(19) United States
(12) Patent Application Publication
(10) Pub. No.: US 2023/0330719 A1
(43) Pub. Date: Oct. 19, 2023

(54) PIPE CLEANING MACHINE

(71) Applicant: Nanjing Chervon Industry Co., Ltd., Nanjing (CN)

(72) Inventors: Hanqing Zheng, Nanjing (CN); Xiangqing Fu, Nanjing (CN); Liang Chen, Nanjing (CN)

(21) Appl. No.: 18/336,155

(22) Filed: Jun. 16, 2023

Related U.S. Application Data
(63) Continuation of application No. PCT/CN2021/138993, filed on Dec. 17, 2021.

(30) Foreign Application Priority Data
Jan. 8, 2021 (CN) 202110023959.7

(51) Int. Cl. E03C 1/302; B08B 9/047

(52) U.S. Cl. CPC B08B 9/047; E03C 1/302; B08B 2209/04

(57) ABSTRACT

A pipe cleaning machine includes: a handle for holding; a drum connected to the handle and rotatable with respect to the handle; a cable disposed in the drum; an electric motor driving the cable to rotate and including an electric motor shaft extending along a first axis; and a cable feeding assembly for feeding the cable. The drum includes an exposed portion, where the ratio of the surface area of the exposed portion to the total surface area of the drum is greater than or equal to 40% and less than or equal to 100%.

### RELATED APPLICATION INFORMATION

This application is a continuation of International Application Number PCT/CN2021/138993, filed on Dec. 17, 2021, through which this application also claims the benefit under 35 U.S.C. §119(a) of Chinese Patent Application No. 202110023959.7 filed Jan. 8, 2021, which applications are incorporated herein by reference in their entirety.

### BACKGROUND

A pipe cleaning machine can assist in cleaning and dredging pipes such as sewers. A conventional pipe cleaning machine is designed to be too large and too heavy. As a result, it is inconvenient for a user to carry the pipe cleaning machine, which increases the fatigue of the user when using the pipe cleaning machine.

### SUMMARY

The present application provides a pipe cleaning machine. The pipe cleaning machine includes: a handle for holding; a drum connected to the handle and rotatable with respect to the handle; a cable disposed in the drum; an electric motor driving the cable to rotate and including an electric motor shaft extending along a first axis; and a cable feeding assembly for feeding the cable. The drum includes an exposed portion exposed to air, where the ratio of the surface area of the exposed portion to the total surface area of the drum is greater than or equal to 40% and less than or equal to 100%.

Optionally, the drum includes a front end facing the cable feeding assembly and a rear end facing the handle, and a projection of the electric motor and a projection of the drum at least partially overlap each other in the radial direction of the first axis.

Optionally, the rear portion of the drum is formed with a mounting cavity, where at least part of the electric motor is placed in the mounting cavity.

Optionally, the pipe cleaning machine further includes a transmission mechanism connecting the electric motor to the cable.

The transmission mechanism is disposed in the mounting cavity.

Optionally, the width of the pipe cleaning machine is greater than or equal to 180 mm and less than or equal to 250 mm, and the length of the pipe cleaning machine is greater than or equal to 430 mm and less than or equal to 550 mm.

The present application provides a pipe cleaning machine. The pipe cleaning machine includes: a handle for holding; a drum connected to the handle and rotatable with respect to the handle; a cable disposed in the drum; an electric motor driving the cable to rotate and including an electric motor shaft extending along a first axis; and a cable feeding assembly for feeding the cable. The drum includes a front end facing the cable feeding assembly, a rear end facing the handle, and a middle portion between the front end and the rear end, and the front end of the drum and at least part of the middle portion are exposed to air.

At least a projection of the electric motor and a projection of the drum overlap each other in the radial direction of the first axis.

The present application provides a pipe cleaning machine. The pipe cleaning machine includes: a handle for holding; a drum connected to the handle and rotatable with respect to the handle; a cable disposed in the drum; an electric motor driving the cable to rotate and including an electric motor shaft extending along a first axis; an electric motor housing connected to the handle and surrounding the electric motor; and a cable feeding assembly for supporting and feeding the cable. The drum is formed with a mounting cavity, and at least part of the electric motor housing is disposed in the mounting cavity.

Optionally, the pipe cleaning machine further includes support members disposed in the mounting cavity and disposed in the circumferential direction of the electric motor housing.

Optionally, a support member includes a connection shaft and a support bearing sleeved on the connection shaft, where the support bearing is rotatable about the connection shaft, and the support bearing is in direct or indirect contact with the inner wall of the drum.

Optionally, support members are included. The support members include a first support member and a second support member, where the first support member is disposed at the rear end of the drum, the second support member is disposed in the handle or the electric motor housing, and the first support member and the second support member are rotatable with respect to each other.

Optionally, either of the first support member and the second support member is an annular rib or an annular groove, where the annular rib and the annular groove are in contact with each other.

Optionally, a pipe cleaning device further includes a support seat disposed below the drum, and a downward projection of the center of gravity of the pipe cleaning machine is in the region where a downward projection of the support seat and a downward projection of the drum overlap each other.

Optionally, a downward projection of the center of gravity of a pipe cleaning device is on the rear middle portion of a downward projection of the drum.

Optionally, support members and the drum are integrally formed.

### BRIEF DESCRIPTION OF DRAWINGS

FIG. 1 is a perspective view of a pipe cleaning machine according to a first example of the present application;

FIG. 2 is a sectional view of the pipe cleaning machine in FIG. 1;

FIG. 3 is a perspective view showing part of structures of the pipe cleaning machine in FIG. 1 from another angle;

FIG. 4 is a structural view of support members of a pipe cleaning machine in the present application;

FIG. 5 is a perspective view of a pipe cleaning machine according to a second example of the present application;

FIG. 6 is a sectional view of the pipe cleaning machine in FIG. 5;

FIG. 7 is a top view of a third example in the present application;

FIG. 8 is a sectional view along the A-A plane in FIG. 7;

FIG. 9 is a sectional view of a fourth example;

FIG. 10 is a perspective view of an output mechanism; and

FIG. 11 is a perspective view of a driving mechanism.

### DETAILED DESCRIPTION

The present application is described below in detail in conjunction with drawings and examples.

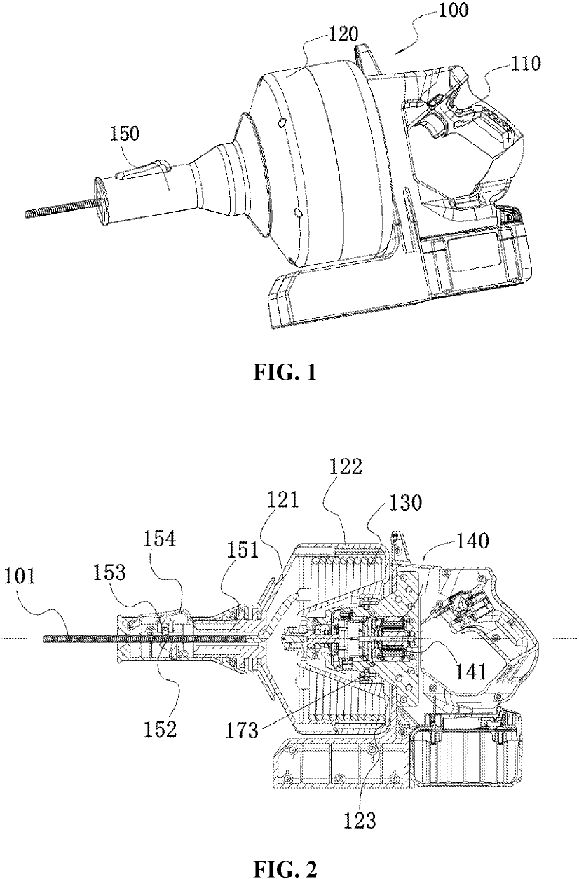

Referring to FIGS. 1 and 2, the present application provides a pipe cleaning machine 100 including a handle 110, a drum 120, a cable 130, and an electric motor 140, where the handle 110 is held by a user, and the drum 120 is connected to the handle 110 and is rotatable with respect to the handle 110. The cable 130 is disposed in the drum 120, and the electric motor 140 can drive the drum 120 and the cable 130 to rotate. The electric motor 140 includes an electric motor shaft 141 rotatable about a first axis 101, where the electric motor shaft 141 and the drum 120 are fixedly connected to each other so that the electric motor 140 drives the drum 120 to rotate. The cable 130 is configured to be twined in the drum 120 and supported by the drum 120 so that the cable 130 can rotate with the drum 120. The pipe cleaning machine 100 further includes a cable feeding assembly 150 for feeding the cable 130. The cable feeding assembly 150 is disposed at the front end 121 of the drum 120, where the cable 130 extends from the inside of the drum 120 into the cable feeding assembly 150, can extend from the cable feeding assembly 150 to a front side, and can retract from the cable feeding assembly 150 to the inside of the drum 120.

The cable 130 is made of an elastic material so that the cable 130 can be wound in the drum 120 and can be bent in a pipe to be cleaned. The cable 130 may be made of a spring steel wire, and a drill bit is disposed on the front portion of the cable 130 and used for removing sundries in the pipe.

The rear end of the cable 130 is twined in the drum 120. When the cable feeding assembly 150 feeds the cable 130, part of the cable 130 twined in the drum 120 is relatively disengaged and fed forward. When finishing using the pipe cleaning machine 100, the user operates the electric motor 140 to cause it to rotate reversely so as to drive the cable 130 to come back into the drum 120 such that the cable 130 is twined in the pipe again.

Optionally, an accessory connection device is disposed on the front portion of the cable 130 and used for mounting other accessories such as a blade or a clamping member.

The cable feeding assembly 150 includes an auxiliary handle 110 and a feeding channel 151 formed in the auxiliary handle 110. The feeding channel 151 supports the cable 130 in an axial direction. The cable 130 can extend forward and retract in the feeding channel 151 along the direction of the first axis 101. The cable 130 extends in the feeding channel 151 substantially along the first axis 101. The cable feeding assembly 150 further includes a fixed roller 152, a movable roller 153, and an operation member 154. The operation member 154 is connected to the movable roller 153 and can cause the movable roller 153 to move in a direction away from or toward the first axis 101. Two fixed rollers 152 are provided, and relative positions of the two fixed rollers 152 are fixed in the auxiliary handle 110. The operation member 154 can move the movable roller 153 to a first position and a second position. The movable roller 153 in the first position is relatively far away from the first axis 101, and the movable roller 153 and the cable 130 are not in contact with each other in this case. When the movable roller 153 is moved to the second position, the movable roller 153 is relatively close to the first axis 101, the movable roller 153 and the cable 130 are in contact with each other in this case, and the movable roller 153 and the fixed roller 152 cooperate with each other to clamp the cable 130. The movable roller 153 and the fixed roller 152 are inclined with respect to the first axis 101. Since the cable 130 is spiral, the rotating cable 130 rotates with respect to the movable roller 153 and the fixed roller 152 so that the rollers can feed the cable 130 from the feeding channel 151 or retract the cable 130. Optionally, the operation member 154 may be a trigger disposed on the auxiliary handle 110. When the user presses the trigger such that the movable roller 153 is in the second position, the trigger is recessed toward the inside of the auxiliary handle 110 so that the surface of the trigger is substantially aligned with the surface of the auxiliary handle 110 or the spacing between the surface of the trigger and the surface of the auxiliary handle 110 is within 5 mm.

The drum 120 includes an exposed portion exposed to air. The ratio of the surface area of the exposed portion to the total surface area of the drum 120 is greater than or equal to 40% and less than or equal to 100%. Optionally, the drum includes the exposed portion exposed to the air. The ratio of the surface area of the exposed portion to the total surface area of the drum is greater than or equal to 20% and less than or equal to 100%.

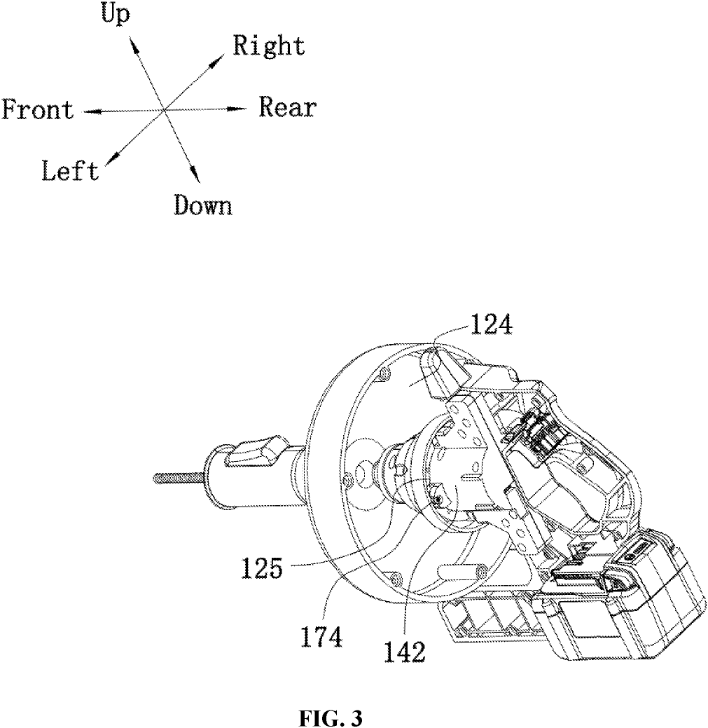

Referring to FIGS. 2 and 3, the rollable drum 120 includes the front end 121 facing the cable feeding assembly 150, a rear end 123 facing the handle 110, and a middle portion 122 between the front end 121 and the rear end 123. A receiving cavity 125 is formed in the drum 120 and used for storing the twined cable 130. The drum 120 is also formed with a mounting cavity 124, where the mounting cavity 124 is formed on the rear portion of the drum 120. In the radial direction of the first axis 101, a projection of the mounting cavity 124 and a projection of the receiving cavity 125 partially overlap each other. Optionally, in the radial direction of the first axis 101, the projection of the mounting cavity 124 is within the projection of the receiving cavity 125 and at least part of the electric motor 140 is placed in the mounting cavity 124. The mounting cavity 124 is formed on the rear middle portion of the drum 120, and the drum 120 has an inner wall forming the mounting cavity 124. Optionally, the mounting cavity 124 is a solid of revolution with the first axis 101 as an axis. The mounting cavity 124 may be a cylinder or a conical frustum. The cable 130 is wound on the circumferential side of the inner wall so that at least part of the electric motor 140 is disposed in the space surrounded by the cable 130. Part of the electric motor 140 is disposed in front of the rear end 123 of the drum 120 in the direction of the first axis 101 so that a projection of the rear end 123 of the drum 120 in the radial direction of the first axis 101 overlaps a projection of the electric motor 140 in this direction.

The pipe cleaning machine 100 further includes a transmission mechanism 160 which connects the electric motor 140 to the cable 130. The transmission mechanism 160 may be a planetary gear set for decelerating the drum 120. The transmission mechanism 160 is connected to the electric motor shaft 141 and can be driven to rotate by the electric motor shaft 141. An output shaft is disposed at the output end of the transmission mechanism 160 and is fixedly connected to the drum 120, and the output shaft and the drum 120 may be connected by a screw. When the electric motor 140 rotates, the transmission mechanism 160 drives drum 120 to decelerate and rotate, and the drum 120 drives the cable 130 to rotate synchronously. The transmission mechanism 160 is disposed in the mounting cavity 124, which further reduces the dimension of the whole pipe cleaning machine 100.

The drum 120 includes the exposed portion exposed to the air so that the ratio of the surface area of the exposed portion of the drum 120 to the total surface area of the drum 120 is greater than or equal to 40% and less than or equal to 100%, for example, the ratio of the surface area of the exposed portion of the drum 120 to the total surface area of the drum 120 is greater than or equal to 65% and less than or equal to 100%. The outer side of part of the drum 120 is provided with no cover. Thus, the dimension of the whole pipe cleaning machine 100 is relatively small so that the weight of the pipe cleaning machine 100 is reduced and the pipe cleaning machine 100 works easily. Optionally, at least part of the front end 121 of the drum 120 and at least part of the middle portion 122 of the drum 120 are exposed to the air, that is, the outer side of the front end 121 of the drum 120 and the outer side of the at least part of the middle portion 122 of the drum 120 are provided with no cover, and only the rear end 123 facing the handle 110 is provided with a protective cover.

The pipe cleaning machine 100 further includes an electric motor housing 142 packing and supporting the electric motor 140, and the electric motor 140 is rotatable in the electric motor housing 142. The electric motor housing 142 is fixedly connected to the handle 110. Optionally, the electric motor housing 142 is fixedly connected to the handle 110 by a screw, or the electric motor housing 142 and the handle 110 are integrally formed through a mold. At least part of the electric motor housing 142 is disposed in the mounting cavity 124, and the shape of the front portion of the electric motor housing 142 is matched with the shape of the mounting cavity 124. The pipe cleaning machine 100 further includes support members 170a disposed in the mounting cavity 124 and disposed in the circumferential direction of the electric motor housing 142. The support members 170a can be in contact with the inner wall of the drum 120 and support the drum 120. A support member 170a includes a connection shaft 173 and a support bearing 174 sleeved on the connection shaft 173, where the support bearing 174 is rotatable about the connection shaft 173, and the support bearing 174 is in direct or indirect contact with the inner wall of the drum 120. The drum 120 is rotatable with respect to the electric motor housing 142 through the support bearing 174 and can be supported by the electric motor housing 142. The screw disposed on the output shaft and the support members 170a cooperate to support the drum 120 together so that the drum 120 is rotatable with respect to the handle 110 and the electric motor housing 142. However, the position of the drum 120 is fixed with respect to the handle 110 in the axial direction of the first axis 101. Optionally, four support members 170a are provided and uniformly distributed in the circumferential direction of the electric motor housing 142 so that the electric motor housing 142 stably supports the drum 120.

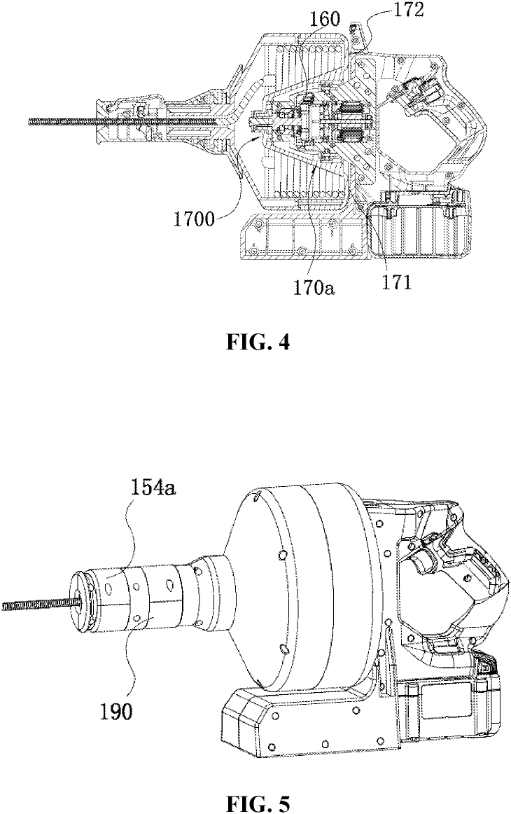

Referring to FIG. 4, optionally, the support members 170a are disposed behind the drum 120. The support members 170a include a first support member 171 and a second support member 172, where the first support member 171 is disposed at the rear end 123 of the drum 120, the second support member 172 is disposed in the handle 110 or the electric motor housing 142, and the first support member 171 and the second support member 172 are rotatable with respect to each other. Either of the first support member 171 and the second support member 172 is an annular rib or an annular groove, where the annular rib and the annular groove are in contact with each other. Thus, the first support member 171 can be embedded in the second support member 172 or the second support member 172 can be embedded in the first support member 171 so that the first support member 171 is rotatable with respect to the second support member 172. Optionally, the first support member 171 is the annular groove, the second support member 172 is the annular rib, and the second support member 172 is configured to be embedded in the first support member 171 so that the connection manner is simple and the length of the whole pipe cleaning machine 100 can be shortened.

The pipe cleaning device further includes a support seat disposed below the drum 120. The support seat can support the whole pipe cleaning machine 100 so that the pipe cleaning machine 100 can be stably placed on a plane. Because of the preceding configuration of the whole pipe cleaning machine 100, the pipe cleaning machine 100 has a reasonable center of gravity, and a downward projection of the center of gravity of the pipe cleaning machine 100 is in the region where a downward projection of the support seat and a downward projection of the drum 120 overlap each other. Thus, the whole machine can stably stand on the plane through the support seat. Optionally, the downward projection of the center of gravity of the pipe cleaning device is on the rear middle portion of the downward projection of the drum 120, thereby reducing the fatigue of the user using the pipe cleaning machine 100. A power supply coupling portion is disposed on a side of the support seat or below the handle and may be connected to a power supply assembly or formed with a power line. When the power supply assembly is connected, the power supply assembly has a plane parallel to the bottom of the support seat, and the plane and the bottom of the support seat together constitute a plane on which the whole machine is placed.

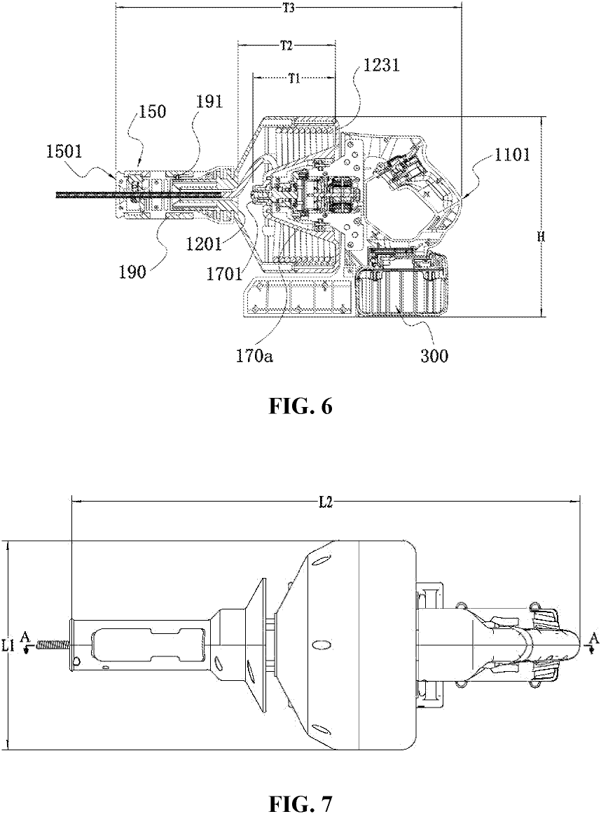

Optionally, referring to FIGS. 5 and 6, the operation member 154a is an annular member sleeved on the auxiliary handle 110, the operation member 154a is rotatable with respect to the auxiliary handle 110, and a raised structure is disposed in the operation member 154a, where when the operation member 154a is rotated to a certain position with respect to the auxiliary handle 110, the raised structure can push the movable roller 153 toward the first axis 101 so that the movable roller 153 moves to the second position. Optionally, a locking member 190 and a locking pin 191 are further disposed on the auxiliary handle 110. The locking member 190 can drive the locking pin 191 to be engaged with and disengaged from the drum 120. When the locking pin 191 is engaged with the drum 120, the drum 120 and the auxiliary handle 110 can rotate synchronously. When the pipe cleaning machine 100 is used, the movable roller 153 is moved to the first position, and the cable 130 is not sent out so that the length of the cable 130 extending out of the auxiliary handle 110 is unchanged. The locking pin 191 causes the drum 120 and the auxiliary handle 110 to rotate synchronously so that the case is avoided where the cable 130 is excessively bent and twisted and the cable 130 is wound and fails to work normally. Optionally, the pipe cleaning machine 100 includes a sleeve sleeved on the outer side of the auxiliary handle, where the sleeve is rotatable with respect to the auxiliary handle, the sleeve is held by the user, and the auxiliary handle is rotatable with respect to the sleeve in this case. Optionally, the sleeve and the operation member 154a are the same annular member.

As shown in FIG. 6, the height of the pipe cleaning machine 100 is denoted as H, and the height is the vertical distance from the top end of the drum to the bottom end of the support seat or the bottom end of the power supply assembly. H is greater than or equal to 200 mm and less than or equal to 350 mm. In particular, H may be greater than or equal to 220 mm and less than or equal to 300 mm. As shown in FIG. 7, the width of the pipe cleaning machine 100 is denoted as L1. Since the proportion of the width of the drum 120 to the width of the whole machine is relatively large and the drum 120 in this example is directly exposed to a working environment, the width may also be considered as the diameter of the drum 120 in this example. In this example, L1 is greater than or equal to 180 mm and less than or equal to 250 mm. In particular, L1 may be greater than or equal to 190 mm and less than or equal to 230 mm. The length of the pipe cleaning machine 100 is denoted as L2, and the length (without the length of the cable) is the vertical distance between the distal end of the cable feeding assembly 150 and the distal end of the handle 110 or the distal end of the power supply assembly. L2 is greater than or equal to 430 mm and less than or equal to 550 mm. In particular, L2 may be greater than or equal to 440 mm and less than or equal to 530 mm.

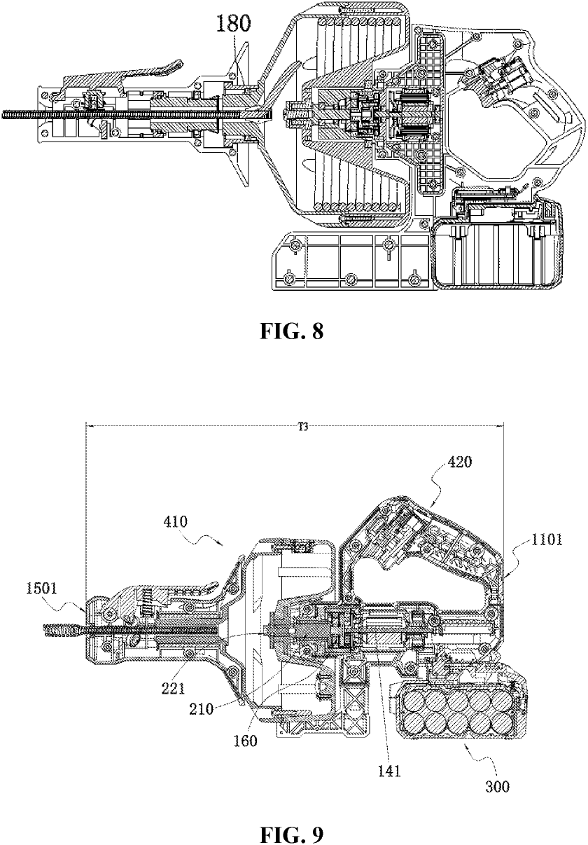

In another example of the pipe cleaning machine 100 as shown in FIG. 8, a sleeve bearing 180 is disposed at the joint between the cable feeding assembly 150 and the drum 120. In the preceding example, this structure and the sleeve are integrally formed into a cylindrical structure having a raised rim. In this example, one end of the sleeve bearing 180 is connected to an end portion of the drum 120 or sleeved outside the end portion of the drum 120, and the other end of the sleeve bearing 180 forms the raised rim connected to the cable feeding assembly 150 or the cable feeding assembly 150 is sleeved on the outer side of the other end. The sleeve bearing 180 may support the drum 120 and the cable feeding assembly 150 which move with respect to each other, thereby reducing friction caused by the direct contact therebetween. In this example, the support members and the housing of the drum 120 may be integrally formed.

As shown in FIG. 6, the rear end 123 of the drum 120 includes a first front surface 1231 located at the front side of the rear end 123. The first front surface 1231 is also the inner surface of the drum 120 where the cable 130 seats. A support mechanism 1700 includes one or more support members 170a, and performs the function of supporting the cable 130 when the cable 130 is rotating. The support mechanism 1700 has a second front surface 1701 located at the most front side of the support mechanism 1700. In the example shown in FIG. 6, the second front surface 1701 located on an outside surface of the gasket, which is the surface towards front of the pipe cleaning machine 100. The drum 120 also has a third front surface 1201, the third front surface 1201 is a most front inner surface of the drum 120.

Define a transmission mechanism depth T1 to be a distance between the second front surface 1701 and the first front surface 1231. Define a total inner depth T2 to be a distance between the third front surface 1201 and the first front surface 1231. A ratio of the transmission mechanism depth T1 to the total inner depth T2 is smaller than 35%. In one example, the ratio of the transmission mechanism depth T1 to the total inner depth T2 is greater than 10% and smaller than 30%. In one example, the ratio T1/T2 is greater than 15% and smaller than 30%. In one example, the ratio T1/T2 is greater than 5% and smaller than 20%. In one example, the power of the electric motor 140 is enlarged. In one example, a force applied to the cable 130 provided by the cable feeding assembly 150 is enlarged.

The cable feeding assembly 150 has a front side which locates at a most front surface of the cable feeding assembly 150. The handle 110 has a rear side locates at a most rear side of the handle 110. Define a first length T3 of the pipe cleaning machine 100 which refers to the length from the front side of 1501 the cable feeding assembly 150 to the rear side 1101 of the handle 110. A small ratio of T1/T2 helps to make a portion of the handle 110, the electric motor 140 and the transmission mechanism 160 as deep inside the drum 120 as possible, so that the first length T3 of the pipe cleaning machine 100 is shortened and the whole machine is more compact.

In one example, the first length of the cable 130 in release state is about 762 cm, which is one of a standard length of the cable 130, and the first length T3 of the pipe cleaning machine 100 is smaller than 380 mm. In one example, for the cable 130 around 762 cm long, the first length T3 of the pipe cleaning machine 100 is smaller than 370 mm. In one example, for the cable 130 around 762 cm long, the first length T3 of the pipe cleaning machine 100 is smaller than 360 mm. In one example, the first length T3 of the pipe cleaning machine 100 is 366 mm.

In some examples, the pipe cleaning machine 100 includes a battery bag 300 supplying battery for the tool. It could be understood that, the first length T3 of the pipe cleaning machine 100 could not consider if the pipe cleaning machine 100 includes the battery bag 300 or if the battery bag 300 extends the rear side 1101 of the handle 110 in the direction of the first axis 101. In FIG. 6, the battery bag 300 is on the front of the rear side 1101. In FIG. 9, the battery bag 300 extents to the rear of the rear side 1101.

From FIG. 9 to FIG. 11, the pipe cleaning machine 100 includes an output mechanism 410 and a driving mechanism 420. The output mechanism 410 includes the cable feeding assembly 150 and drum 120. The driving mechanism 420 includes the handle 110 and battery bag 300.

The receiving cavity 125 accommodates at least a part of the transmission mechanism 160. In the example in FIGS. 2, 4 and 6, the receiving cavity 125 also accommodates at least a part of the electric motor shaft 141 of the electric motor 140. In the example in FIGS. 2, 4 and 6, the receiving cavity 125 also accommodates at least a part of rotor of the electric motor 140. That is to say, in the direction of the first axis 101, a projection of the drum 120 to the first axis 101 overlaps with a projection of the motor rotor to the first axis 101.

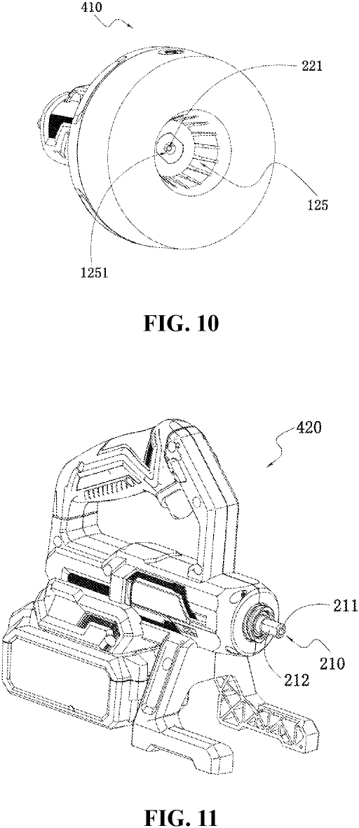

The transmission mechanism 160 is driven by the electric motor 140, so that the output shaft 210 drives the drum 120 to rotate. In FIG. 10, a second screw 221 fits with the output shaft 210. In FIG. 10, there is a first installation portion 1251 inside the receiving cavity 125. In FIG. 11, there is a second installation portion 212 on the output shaft 210. The first installation portion 1251 and the second installation portion 212 fits with each other by same or similar shape. In one example, the first installation portion 1251 has two inner flat surfaces, and the second installation portion has two flat surfaces.

What is claimed is:

1. A pipe cleaning machine, comprising:
a handle for holding;
a drum connected to the handle and rotatable with respect to the handle;
a cable disposed in the drum;
an electric motor driving the cable to rotate and comprising an electric motor shaft extending along a first axis;
an electric motor housing connected to the handle and surrounding the electric motor; and
a cable feeding assembly for supporting and feeding the cable;
wherein the drum is formed with a mounting cavity, and at least part of the electric motor housing is disposed in the mounting cavity.

2. The pipe cleaning machine according to claim 1, further comprising support members disposed in the mounting cavity and disposed in a circumferential direction of the electric motor housing.

3. The pipe cleaning machine according to claim 2, wherein the support member comprises a connection shaft and a support bearing sleeved on the connection shaft, the support bearing is rotatable about the connection shaft, and the support bearing is in direct or indirect contact with an inner wall of the drum.

4. The pipe cleaning machine according to claim 1, further comprising support members comprising a first support member and a second support member, wherein the first support member is disposed at a rear end of the drum, the second support member is disposed in the handle or the electric motor housing, and the first support member and the second support member are rotatable with respect to each other.

5. The pipe cleaning machine according to claim 4, wherein a one of the first support member and the second support member is an annular rib and the other of the first support member and the second support member is an annular groove and the annular rib and the annular groove are in contact with each other.

6. The pipe cleaning machine according to claim 1, wherein the pipe cleaning device further comprises a support seat disposed below the drum, and a downward projection of a center of gravity of the pipe cleaning machine is in a region where a downward projection of the support seat and a downward projection of the drum overlap each other.

7. The pipe cleaning machine according to claim 1, wherein a downward projection of a center of gravity of the pipe cleaning device is on a rear middle portion of a downward projection of the drum.

8. The pipe cleaning machine according to claim 2, wherein the support members and the drum are integrally formed.

9. The pipe cleaning machine according to claim 1, wherein the drum comprises a front end facing the cable feeding assembly and a rear end facing the handle, and a projection of the electric motor and a projection of the drum at least partially overlap each other in a radial direction of the first axis.

10. The pipe cleaning machine according to claim 1, wherein a width of the pipe cleaning machine is greater than or equal to 180 mm and less than or equal to 250 mm, and a length of the pipe cleaning machine is greater than or equal to 430 mm and less than or equal to 550 mm.

11. The pipe cleaning machine according to claim 1, wherein at least a projection of the electric motor and a projection of the drum overlap each other in a radial direction of the first axis.

12. A pipe cleaning machine, comprising:
a handle for holding;
a drum connected to the handle and rotatable with respect to the handle;
a cable disposed in the drum;
an electric motor driving the cable to rotate and comprising an electric motor shaft extending along a first axis; and
a cable feeding assembly for supporting and feeding the cable;
wherein the drum is formed with a mounting cavity, and at least part of the electric motor is disposed in the mounting cavity.

13. The pipe cleaning machine according to claim 12, further comprising support members disposed in the mounting cavity and disposed in a circumferential direction of the electric motor housing.

14. The pipe cleaning machine according to claim 13, wherein the support member comprises a connection shaft and a support bearing sleeved on the connection shaft, the support bearing is rotatable about the connection shaft, and the support bearing is in direct or indirect contact with an inner wall of the drum.

15. The pipe cleaning machine according to claim 12, further comprising support members comprising a first support member and a second support member, wherein the first support member is disposed at a rear end of the drum, the second support member is disposed in the handle or the electric motor housing, and the first support member and the second support member are rotatable with respect to each other.

16. The pipe cleaning machine according to claim 15, wherein a one of the first support member and the second support member is an annular rib and the other of the first support member and the second support member is an annular groove and the annular rib and the annular groove are in contact with each other.

17. The pipe cleaning machine according to claim 12, wherein the pipe cleaning device further comprises a support seat disposed below the drum, and a downward projection of a center of gravity of the pipe cleaning machine is in a region where a downward projection of the support seat and a downward projection of the drum overlap each other.

18. The pipe cleaning machine according to claim 12, wherein a downward projection of a center of gravity of the pipe cleaning device is on a rear middle portion of a downward projection of the drum.

19. The pipe cleaning machine according to claim 12, wherein the rear end 123 of the drum 120 includes a first front surface 1231 located at a front side of the rear end 123, the support mechanism 1700 has a second front surface 1701 located at the most front side of the support mechanism 1700, a transmission mechanism depth T1 is defined to be a distance between the second front surface 1701 and the first front surface 1231, a total inner depth T2 is defined to be a distance between the third front surface 1201 and the first front surface 1231, and a ratio of the transmission mechanism depth T1 to the total inner depth T2 is smaller than 35%.

20. The pipe cleaning machine according to claim 19, wherein the ratio of the transmission mechanism depth T1 to the total inner depth T2 is greater than 15% and smaller than 30%.
